(19) United States
(12) Patent Application Publication
(10) Pub. No.: US 2024/0284087 A1
(43) Pub. Date: Aug. 22, 2024

(54) ACOUSTIC OUTPUT DEVICES

(71) Applicant: SHENZHEN SHOKZ CO., LTD., Shenzhen (CN)

(72) Inventors: Yongjian LI, Shenzhen (CN); Yu XU, Shenzhen (CN); Zhen WANG, Shenzhen (CN); Lei ZHONG, Shenzhen (CN)

(73) Assignee: SHENZHEN SHOKZ CO., LTD., Shenzhen (CN)

(21) Appl. No.: 18/650,028

(22) Filed: Apr. 29, 2024

Related U.S. Application Data
(63) Continuation of application No. PCT/CN2022/119806, filed on Sep. 20, 2022.

(51) Int. Cl. H04R 1/10

(52) U.S. Cl. CPC H04R 1/105; H04R 1/1025; H04R 1/1075

(57) ABSTRACT

The embodiments of the present disclosure provide a loudspeaker configured to convert an audio signal into a sound signal; a housing configured to carry the loudspeaker and include an outlet hole in acoustic communication with the loudspeaker; and a fixing mechanism configured to support the housing such that the outlet hole is placed near an ear of a user and the housing does not block an earhole of the user, wherein on a same sagittal plane, a projection of the outlet hole is within a target region with a projection of the earhole of the user as a center and a radius of 20 mm.

### CROSS REFERENCE TO RELATED APPLICATIONS

The present application is a Continuation of International Application No. PCT/CN2022/119806 filed on Sep. 20, 2022, the entire contents of which are incorporated herein by reference.

### TECHNICAL FIELD

The present disclosure relates to the technical field of acoustic devices, and in particular, to acoustic output devices.

### BACKGROUND

Acoustic output devices (e.g., headphones) have been widely used in people's daily lives, and the acoustic output devices can be used in conjunction with electronic devices, such as cellular phones and computers, to provide an auditory feast for the user. Acoustic output devices can be in different forms. For example, the acoustic output devices may be integrated into eyeglasses (e.g., sunglasses, swimming glasses, etc.) or may be fixed in or near the ear of a user by a specific structure (e.g., an ear hook). The comfort and stability of wearing the acoustic device can greatly influence the choice and experience of the user. Therefore, it is desirable to provide an acoustic output device with high wearing comfort and good output sound quality.

### SUMMARY

According to some embodiments of the present disclosure, an acoustic output device is provided. The acoustic output device may include: a loudspeaker, a housing, and a fixing mechanism. The loudspeaker may be configured to convert an audio signal into a sound signal. The housing may be configured to carry the loudspeaker and include an outlet hole in acoustic communication with the loudspeaker. The fixing mechanism may be configured to support the housing such that the outlet hole is placed near an ear of a user and the housing may not block an earhole of the user, wherein on a sagittal plane, a projection of the outlet hole may be within a target region with a projection of the earhole of the user as a center and a radius of 20 mm.

In some embodiments, the housing may include a contact surface configured to contact a face of the user when the user wears the acoustic output device.

In some embodiments, a ratio of an area of a portion of the contact surface that is in contact with the face of the user to a total area of the contact surface may be within a range of 0.05 to 1.

In some embodiments, the contact surface may include a recessed portion, and the recessed portion may be configured such that at least a portion of the housing bypasses a tragus of the user such that the projection of the outlet hole is within the target region.

In some embodiments, the recessed portion may include a chamfer structure or an arc structure.

In some embodiments, an arc degree corresponding to the chamfer structure or the arc structure may be within a range of 80° to 120°.

In some embodiments, a width of the recessed portion along a sagittal axis direction may be greater than 7 mm.

In some embodiments, a depth of the recessed portion along a coronal axis direction may be greater than 4.4 mm.

In some embodiments, when the user wears the acoustic output device, a pressure of the contact surface on a tragus of the user may be within a range of 0 to 2 kPa.

In some embodiments, the housing may include a body and a sound guide tube, a projection of the body on the sagittal plane may be outside a projection of an auricle of the user on the sagittal plane, the loudspeaker may be disposed within the body, and the outlet hole may be in acoustic communication with the loudspeaker through the sound guide tube.

In some embodiments, the sound guide tube may be configured to bypass the tragus of the user such that the outlet hole is within the target region.

In some embodiments, a length of the sound guide tube may be within a range of 1 mm to 30 mm.

In some embodiments, a minimum cross-sectional area of the sound guide tube may be greater than 2 mm².

In some embodiments, a vibration direction of the loudspeaker may be parallel to an orientation of the outlet hole.

In some embodiments, the vibration direction of the loudspeaker may be perpendicular to the orientation of the outlet hole.

In some embodiments, the acoustic output device may further include a power supply and a circuit board. The power assembly may be configured to provide electrical power to the acoustic output device. The circuit board may be configured to connect two or more components of the acoustic output device, wherein projections of the power supply assembly and the circuit board on the sagittal plane may be outside a projection of an auricle of the user on the sagittal plane.

In some embodiments, the outlet hole may face the earhole of the user.

In some embodiments, the outlet hole may face the concha cavity of the user.

In some embodiments, on the same sagittal plane, an angle between a line connecting the projection of the outlet hole and the projection of the earhole and a negative direction of a sagittal axis may be within a range of 60° to 90°.

According to some embodiments of the present disclosure, an acoustic output device is provided. The acoustic output device may include a loudspeaker, a housing, and a fixing mechanism. The loudspeaker may be configured to convert the audio signal into the sound signal. The housing may be configured to carry the loudspeaker and include the outlet hole in acoustic communication with the loudspeaker. The fixing mechanism may be configured to support the housing such that the outlet hole is placed near the ear of the user and the housing may block the earhole of the user, wherein the at least a portion of the housing may bypass the tragus of the user and include the output hole.

In some embodiments, on a sagittal plane, the projection of the outlet hole is in a target region with the projection of the earhole of the user as the center and the radius of 20 mm.

In some embodiments, the housing may include a contact surface, and when the user wears the acoustic output device, the contact surface may contact a face of the user.

In some embodiments, a ratio of an area of a portion of the contact surface that is in contact with the face of the user to the total area of the contact surface may be within a range of 0.05 to 1.

In some embodiments, the contact surface includes the recessed portion, and the recessed portion may be configured such that the at least a portion of the housing bypasses the tragus of the user such that the projection of the outlet hole may be located within the target region.

In some embodiments, the recessed portion may include a chamfer structure or an arc structure.

In some embodiments, an arc degree corresponding to the chamfer structure or the arc structure may be within a range of 80° to 120°.

In some embodiments, the width of the recessed portion along the sagittal axis direction may be greater than 7 mm.

In some embodiments, the depth of the recessed portion along the coronal axis direction may be greater than 4.4 mm.

In some embodiments, when the user wears the acoustic output device, the pressure of the contact surface on a tragus of the user may be within a range of 0 to 2 kPa.

In some embodiments, the housing may include the body and the sound guide tube, a projection of the body on the sagittal plane may be outside a projection of an auricle of the user on the sagittal plane, the loudspeaker may be disposed within the body, and the outlet hole may be in acoustic communication with the loudspeaker through the sound guide tube.

In some embodiments, the sound guide tube may be configured to bypass the tragus of the user so that the outlet hole is located within the target region.

In some embodiments, the length of the sound guide tube may be within a range of 1 mm to 30 mm.

In some embodiments, the minimum cross-sectional area of the sound guide tube may be greater than 2 mm².

In some embodiments, the acoustic output device may further include a power supply and a circuit board. The power assembly may be configured to provide the electrical power to the acoustic output device. The circuit board may be configured to connect two or more components of the acoustic output device, wherein projections of the power supply assembly and the circuit board on the sagittal plane may be outside a projection of an auricle of the user on the sagittal plane.

In some embodiments, the vibration direction of the loudspeaker may be parallel to the orientation of the outlet hole.

In some embodiments, the vibration direction of the loudspeaker may be perpendicular to the orientation of the outlet hole.

In some embodiments, the outlet hole may face the earhole of the user.

In some embodiments, the outlet hole may face the concha cavity of the user.

In some embodiments, on the sagittal plane, the angle between the line connecting the outlet hole and the earhole and the negative direction of the sagittal axis may be within a range of 60° to 90°.

### BRIEF DESCRIPTION OF THE DRAWINGS

The present disclosure will be further described by way of exemplary embodiments, which will be described in detail through the present drawings. These embodiments are not limiting, and in these embodiments, the same numbering indicates the same structure, wherein:

FIG. 1 is a block diagram illustrating an acoustic output device according to some embodiments of the present disclosure;

FIGS. 2A-2C are schematic diagrams illustrating acoustic output devices according to some embodiments of the present disclosure;

FIGS. 3A and 3B are schematic diagrams illustrating three-dimensional Cartesian coordinate systems according to some embodiments of the present disclosure;

FIG. 4 is a schematic diagram illustrating a position relationship between an acoustic output device and an ear of a user in a wearing state according to some embodiments of the present disclosure;

FIG. 5 is a schematic diagram illustrating an acoustic output device according to some embodiments of the present disclosure;

FIG. 6 is a schematic diagram illustrating a position relationship between an acoustic output device and an ear of a user in a wearing state according to some embodiments of the present disclosure;

FIG. 7 is a schematic diagram illustrating a position relationship between an acoustic output device and an ear of a user in a wearing state according to some embodiments of the present disclosure;

FIG. 8 is a schematic diagram illustrating a position relationship between an outlet hole and an ear of a user according to some embodiments of the present disclosure;

FIG. 9 is a schematic diagram illustrating different orientations of an outlet hole according to some embodiments of the present disclosure;

FIG. 10 is a schematic diagram illustrating frequency response curves of sound emitted by outlet holes of different orientations at an ear of a user according to some embodiments of the present disclosure;

FIG. 11 is a schematic diagram illustrating a position relationship between an outlet hole and an ear of a user according to some embodiments of the present disclosure;

FIG. 12 is a schematic diagram illustrating outlet holes located at different positions according to some embodiments of the present disclosure;

FIG. 13 is a schematic diagram illustrating frequency response curves of sound emitted by outlet holes located at different positions at an ear of a user according to some embodiments of the present disclosure;

FIG. 14 is a schematic diagram illustrating a position relationship between an outlet hole and an ear of a user according to some embodiments of the present disclosure;

FIG. 15 is a schematic diagram illustrating outlet holes located at different positions according to some embodiments of the present disclosure;

FIG. 16 is a schematic diagram illustrating frequency response curves of sound emitted by outlet holes located at different positions at an ear of a user according to some embodiments of the present disclosure;

FIG. 17 is a schematic diagram illustrating another exemplary acoustic output device according to some embodiments of the present disclosure;

FIG. 18 is a schematic diagram illustrating another exemplary acoustic output device according to some embodiments of the present disclosure;

FIG. 19 is a schematic diagram illustrating another exemplary acoustic output device according to some embodiments of the present disclosure.

### DETAILED DESCRIPTION

To illustrate the technical solutions related to the embodiments of the present disclosure, a brief introduction of the drawings referred to in the description of the embodiments is provided below. Obviously, the drawings described below are only some examples or embodiments of the present disclosure. Those skilled in the art, without further creative efforts, may apply the present disclosure to other similar scenarios according to these drawings. Unless apparent from the locale or otherwise stated, like reference numerals represent similar structures or operations throughout the several views of the drawings.

It will be understood that the terms “system,” “device,” “unit,” and/or “module” used herein are one method to distinguish different components, elements, parts, sections, or assembly of different levels in ascending order. However, the terms may be displaced by another expression if they achieve the same purpose. As used in the disclosure and the appended claims, the singular forms “a,” “an,” and/or “the” may include plural forms unless the content clearly indicates otherwise. In general, the terms “comprise,” “comprising,” “include,” and/or “including” merely prompt to include steps and elements that have been clearly identified, and these steps and elements do not constitute an exclusive listing. The methods or devices may also include other steps or elements. Relevant definitions of other terms will be given in the following description. Hereinafter, without loss of generality, the description “acoustic output device” will be used in describing the technology in the present disclosure. For those skilled in the art, the “acoustic output device” may be displaced by other terms of the same type, such as “earphone,” “player,” “hearing aid,” and the like. In fact, the various implementations of the present application may be easily applied to other non-loudspeaker hearing devices. For example, for those skilled in the art, after understanding the basic principle of the acoustic output device, it is possible, without departing from this principle, to make various corrections and changes in form and details to the specific ways and steps of implementing the acoustic output device, and in particular, to add an ambient sound pickup and processing function to the acoustic output device, to enable the acoustic output device to realize the function of a hearing aid. For example, a loudspeaker such as a microphone may pick up sounds of the environment around the user/wearer, and under certain algorithms, process the sounds (or generate electrical signals) and transmit them to a speaker portion of the acoustic output device. That is, the acoustic output device may be modified in a certain manner to incorporate a function of picking up the environmental sound and transmitting the sound to the user/wearer through the loudspeaker portion of the acoustic output device after a certain signal processing, thereby realizing the function of the hearing aid. As an example, the algorithms described herein may include one or a combination of noise cancellation, automatic gain control, acoustic feedback suppression, wide dynamic range compression, active environmental recognition, active anti-noise, directional processing, tinnitus processing, multi-channel wide dynamic range compression, active whistling suppression, volume control, and the like.

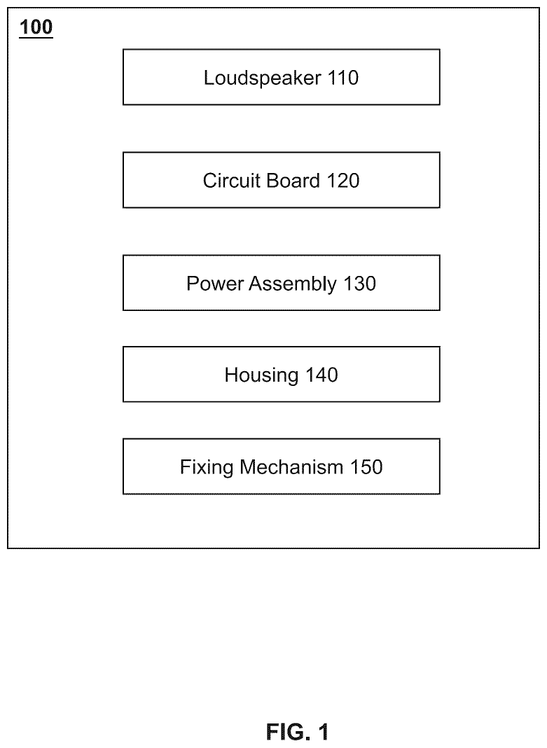

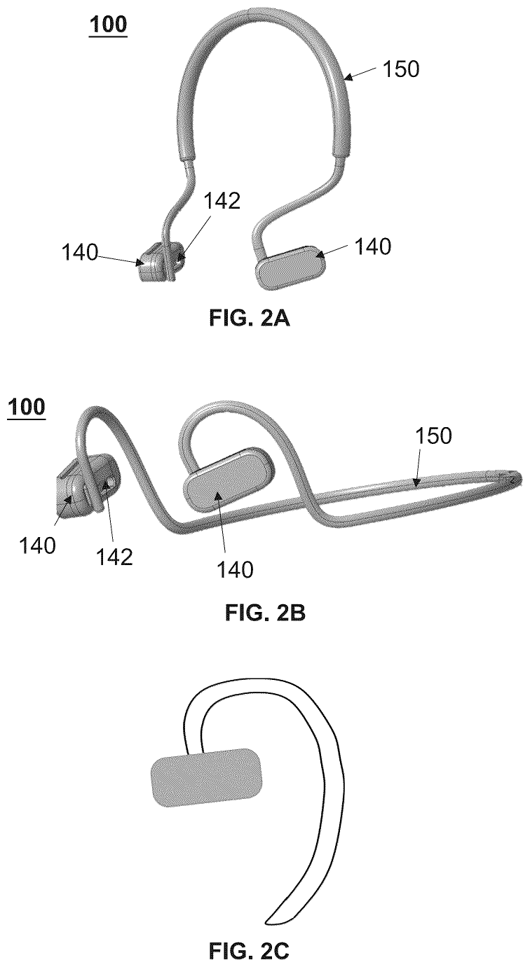

FIG. 1 is a block diagram illustrating an acoustic output device according to some embodiments of the present disclosure. FIG. 2A-FIG. 2C are schematic diagrams illustrating acoustic output devices according to some embodiments of the present disclosure. As shown in FIG. 1 and FIGS. 2A-2C, an acoustic output device 100 may include a loudspeaker 110, a circuit board 120, a power supply assembly 130, a housing 140, and a fixing mechanism 150. The loudspeaker 110, the circuit board 120, and the power supply assembly 130 may be disposed within the housing 140, and the housing 140 may be connected to the fixing mechanism 150.

The loudspeaker 110 may receive an audio signal and convert the audio signal into a sound signal. In some embodiments, the audio signal may include a video file or an audio file with a specific data format, or data or a file that may be converted into sound in a specific manner. For example, the audio signal may include an electrical signal, an optical signal, a magnetic signal, a mechanical signal, or the like, or any combination thereof. The loudspeaker 110 may convert the audio signal to produce the sound signal. For example, the loudspeaker 110 may convert the electrical signal into a mechanical vibration to produce the sound. As another example, the audio signal may be contained in the optical signal, and the loudspeaker 110 may convert the optical signal into a vibration signal. In some embodiments, the loudspeaker 110 may include a moving coil loudspeaker, an electrostatic loudspeaker, a piezoelectric loudspeaker, a moving iron loudspeaker, a pneumatic loudspeaker, an electromagnetic loudspeaker, or the like.

The circuit board 120 may be configured to connect different components in the acoustic output device 100. For example, the circuit board 120 may be configured to connect the power supply assembly 130 and the loudspeaker 110. In some embodiments, the circuit board 120 may be a flexible printed circuit (FPC). The flexible circuit board is highly flexible and may fit an interior space of the housing 140, which facilitates installation.

The power supply assembly 130 may be configured to provide electrical power to one or more components in the acoustic output device 100. In some embodiments, the power supply assembly 130 may include a flexible circuit board, a battery, or the like. The flexible circuit board may be configured to connect the battery and other components (e.g., the loudspeaker 110) in the acoustic output device 100 to provide the electrical power for the operation of the components.

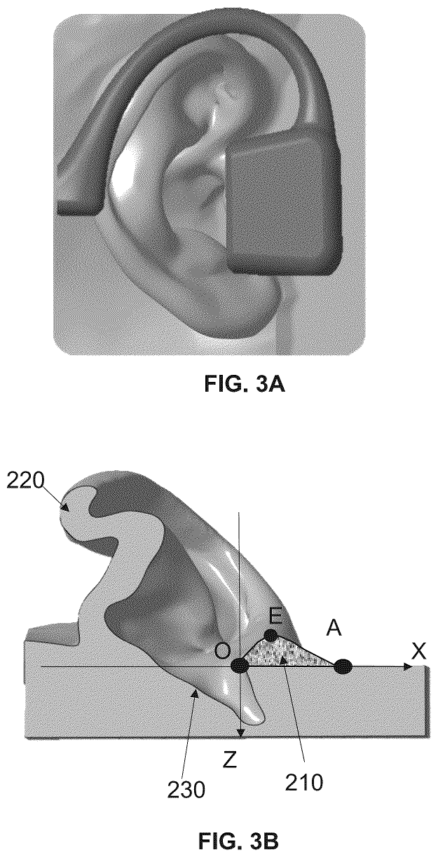

The housing 140 may provide an installing platform and a working space for other components of the acoustic output device 100. In some embodiments, the housing 140 may form one or more enclosed or non-enclosed accommodating spaces, and the power supply assembly 130, the circuit board 120, and the loudspeaker 110, etc. may be disposed inside the housing 140. In some embodiments, the acoustic output device 100 may be an air-conduction acoustic output device configured to transmit the sound signal to a user through air conduction. For example, the housing 140 may include one or more outlet holes 142, the one or more outlet holes 142 may be in flow communication with the loudspeaker 110, and the sound generated by the loudspeaker 110 may be transmitted to an ear of the user through the one or more outlet holes 142. In some embodiments, the acoustic output device 100 may be a bone-conduction acoustic output device configured to transmit the sound signal to the user through bone-conduction. For example, the housing 140 may include one or more contact surfaces, and the contact surfaces may contact or attach a head of the user (e.g., a face of the user) and may be configured to transmit a vibration generated by the loudspeaker 110 to auditory nerves of the user through bones such that the user can hear the sound. The housing 140 may be directly or indirectly connected to the loudspeaker 110 to transmit the vibration signal from the loudspeaker 110 to the auditory nerves via the bones. In some embodiments, the acoustic output device 100 may be a combined bone-conduction and air-conduction acoustic output device configured to transmit the sound generated by the loudspeaker 110 through bone-conduction and air conduction, simultaneously or respectively. More descriptions regarding the outlet hole 142 may be found in FIG. 3A-FIG. 19 and related descriptions thereof and will not be repeated herein.

The fixing mechanism 150 may fix and support the housing 140, thereby maintaining a stable wearing of the acoustic output device 100. In some embodiments, the fixing mechanism 150 may be configured to support the housing 140 such that the outlet hole 142 is placed near the ear of a user (e.g., an earhole) and the housing 140 does not block the earhole of the user. In some embodiments, the fixing mechanism 150 may be configured to place the housing 140 in a region outside an auricle (e.g., a front side of the auricle) when the user wears the acoustic output device 100. For example, a projection of the housing 140 and the one or more components included therein (e.g., the loudspeaker 110, the circuit board 120, and the power supply assembly 130, etc.) on a sagittal plane of the user (e.g., a XOY plane shown in FIG. 3A) may be outside a projection of the auricle of the user. In some embodiments, the fixing mechanism 150 may include one or more fixing connectors. The one or more fixing connectors may be connected to the housing 140. In some embodiments, the fixing mechanism 150 may enable a binaural wearing. As shown in FIG. 2A and FIG. 2B, for example, both ends of the fixing mechanism 150 may be fixedly connected to two housings 140, respectively. When the user wears the acoustic output device 100, the fixing mechanism 150 may place the two housings 140 and the loudspeakers 110 corresponding to the two housings 140 near the left and right ears of the user, respectively. In some embodiments, the fixing mechanism 150 may have a preset pattern to enable different wearing manners of the acoustic output device 100. For example, FIG. 2A shows a head-mounted binaural wearable acoustic output device 100, in which the fixing mechanism 150 may be attached to the head of the user, thereby enabling the wearing of the acoustic output device 100. As another example, as shown in FIG. 2B, the fixing mechanism 150 may include an ear hook and a rear hook, which may be attached to the rear side of the neck of the user, thereby enabling the wearing of the acoustic output device 100. In some embodiments, the fixing mechanism 150 may also achieve a monaural wearing. For example, as shown in FIG. 2C, the fixing mechanism 150 may include an ear hook, which may be fixedly connected to merely one housing 140. When the user wears the acoustic output device 100, the fixing mechanism 150 may place the housing 140 and a corresponding loudspeaker 110 corresponding to the housing 140 near the ear on one side of the user. In some embodiments, the fixing mechanism 150 may include one or more of an eyewear (e.g., sunglasses, augmented reality eyewear, virtual reality eyewear), a helmet, a hair band, or the like, or any combination thereof, which is not limited in the present disclosure.

The descriptions of the acoustic output device 100 described above are merely provided for illustration and are not intended to limit the scope of the present disclosure. For those skilled in the art, a wide variety of amendments and variations may be made based on the descriptions of the present disclosure. For example, the components and/or function of the acoustic output device 100 may be altered or changed according to specific embodiments. For example, the acoustic output device 100 may include a storage component configured to store a signal containing audio information. As another example, the acoustic output device 100 may include one or more processors, and the processors may execute one or more sound signal processing algorithms configured to process the sound signal. For example, the one or more sound signal processing algorithms configured to perform a noise reduction, an acoustic feedback suppression, a wide dynamic range compression, an automatic gain control, an active environmental recognition, an active anti-noise, a directional processing, a tinnitus processing, a multi-channel wide dynamic range compression, an active whistling suppression, a volume control, or the like, or any combination thereof on the sound signal, these variations and amendments remain within the scope of protection of the present disclosure.

To enable the user to obtain sound with a better sound quality and a higher volume when wearing the acoustic output device 100, the one or more outlet holes 142 of the acoustic output device 100 may be placed near the earhole of the user.

To facilitate describing a configuration of positions of the one or more outlet holes, a three-dimensional(3D) Cartesian coordinate system may be constructed based on a standard human ear structure, which may be a human ear model known to the public in the industry, such as GRAS KB5000 or GRAS KB5001. FIG. 3A and FIG. 3B are schematic diagrams illustrating a three-dimensional Cartesian coordinate system according to some embodiments of the present disclosure. In conjunction with FIG. 3A and FIG. 3B, in some embodiments, a three-dimensional Cartesian coordinate system may be constructed with a point of the auricle 210 of the user closest to the auricle 220 as an origin O, with a horizontal direction as an X-axis direction, with a standing direction of the human body as a Y-axis direction, and with a direction perpendicular to an XOY plane as a Z-axis direction. The horizontal direction is a sagittal axis direction corresponding to the standard human ear structure, the standing direction of the human body is a vertical axis direction corresponding to the standard human ear structure, and a direction perpendicular to the XOY plane is a coronal axis direction corresponding to the standard human ear structure. The XOY plane (or a Z-axis origin) is coplanar with a face plane on the front side of the tragus 210, a positive direction of the X-axis (or the positive direction of the sagittal axis) is a direction away from an earhole 230 in the face plane on the front side of the tragus 210, a positive direction of the Y-axis (or the positive direction of the vertical axis) is a direction in which the human body stands vertically upward (i.e., a direction pointing to a top of the head from a ground plane), a positive direction of the Z-axis (or the positive direction of the coronal axis) is a direction perpendicular to the face plane on the front side of the tragus 210 and pointing to the earhole 230. In some embodiments, the origin O may be located within a projection of the earhole 230 on the XOY plane. For example, a projection of a geometric center of the earhole 230 on the XOY plane may overlap or be close to the origin O. In such cases, on the XOY plane, the position of the earhole 230 or its geometric center may be represented by the origin O. Correspondingly, in some embodiments, the origin O and the earhole 230 may be used interchangeably.

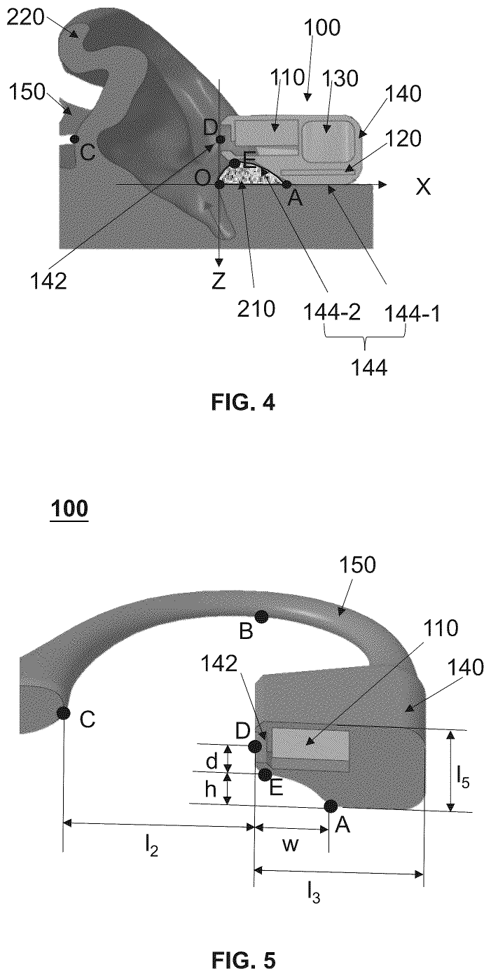

In some embodiments, to enable the user to obtain sound with better sound quality and a higher volume when wearing the acoustic output device 100, a projection of the position of the outlet hole 142 on the XOY plane (or on the same sagittal plane) may be located within a target region. In some embodiments, the outlet hole 142 may be a hole with a small area (e.g., an area smaller than 0.5 mm²), and a coordinate position where an entirety of the outlet hole 142 is located may be used as the position of the outlet hole 142. In some embodiments, the outlet hole 142 may be one or more holes with a relatively large area (e.g., an area greater than 0.5 mm²), and a coordinate position where a center point of the outlet hole 142 (e.g., a center point D shown in FIG. 4) is located may be used as the position of the outlet hole 142. In some embodiments, the target region may include a circular region with the origin O as a center and a radius of r (e.g., a circular region 240 shown in FIG. 3A). In some embodiments, r may be within a range of 10 mm to 30 mm such that the user may hear sound with a relatively good sound quality and a relatively high volume when wearing the acoustic output device 100, thereby improving an output effect of the acoustic output device 100. In some embodiments, r may be within a range of 15 mm to 25 mm. In some embodiments, r may be within a range of 18 mm to 22 mm. Merely by way of example, a value of r may be 20 mm. In some embodiments, to further improve an output volume of the acoustic output device 100 to the earhole while avoiding obstructing a transmission of external sound to the earhole, r may be within a range of 2 mm to 8 mm. Merely by way of example, the value of r may be 3 mm, 5 mm, etc. In some embodiments, a total area of the outlet holes 142 may be configured to further improve the output effect of the acoustic output device 100. For example, the total area of the outlet holes 142 may be within a range of 1 mm² to 50 mm². As another example, the total area of the outlet holes 142 may be within a range of 5 mm² to 30 mm².

FIG. 4 is a schematic diagram illustrating a positional relationship between an acoustic output device and an ear of a user in a wearing state according to some embodiments of the present disclosure. In some embodiments, as shown in FIG. 4, the housing 140 of the acoustic output device 100 may include a contact surface 144, and at least a portion of the contact surface 144 may be in contact with the face of the user when the user wears the acoustic output device 100, thereby causing the acoustic output device 100 to be fixed relative to the face of the user. For example, as shown in FIG. 4, the contact surface 144 may include an attaching portion 144-1 that is in contact with the face of the user. The attaching portion 144-1 may be attached to the face of the user on the front side of the tragus 210 of the user when the user wears the acoustic output device 100 such that a center of gravity of the housing 140 may be located on the face of the user on the front side of the tragus 210 of the user. In some embodiments, a ratio of an area of the attaching portion 144-1 to a total area of the contact surface 144 may be greater than a preset threshold to ensure the stability and comfort of the acoustic output device 100 when the user wears the acoustic output device 100. In some embodiments, the ratio of the area of the attaching portion 144-1 to the total area of the contact surface 144 may not be too large in terms of actual production and use scenarios. For example, the ratio of the area of the attaching portion 144-1 to the total area of the contact surface 144 may be within a range of 0.05 to 1. As another example, the ratio of the area of the attaching portion 144-1 to the total area of the contact surface 144 may be within a range of 0.2 to 0.8. As another example, the ratio of the area of the attaching portion 144-1 to the total area of the contact surface 144 may be within a range of 0.5 to 0.7. Merely by way of example, the area of the attaching portion 144-1 may be within a range of 50 mm² to 400 mm² and the total area of the contact surface 144 may be within a range of 100 mm² to 600 mm². In some embodiments, the acoustic output device 100 may be an acoustic output device that utilizes bone conduction and air conduction. The attaching portion 144-1 may be configured to attach to the face of the user to transmit the vibration signal. In some embodiments, the area of the attaching portion 144-1 may be larger than a preset threshold to ensure the transmission efficiency of the acoustic output device 100 in transmitting the vibration signal. For example, the area of the attaching portion 144-1 may be larger than 25 mm². As another example, the area of the attaching portion 144-1 may be larger than 100 mm² As another example, the area of the attaching portion 144-1 may be larger than 200 mm².

In some embodiments, since the tragus 210 is higher than the face of the user, when the user wears the acoustic output device 100, the housing 140 (or the contact surface 144) may cause relatively great pressure on the tragus 210, which affects comfort of the user when wearing the acoustic output device 100. Therefore, in some embodiments, the housing 140 (or the contact surface 144) may be configured so that the pressure of the housing 140 (or the contact surface 144) on the tragus 210 of the user is within a preset range. For example, the pressure of the contact surface 144 on the tragus 210 of the user may be within a range of 0 to 10 kPa to improve the wearing comfort of the acoustic output device 100. As another example, the pressure of the contact surface 144 on the tragus 210 of the user may be within a range of 0 to 6 kPa. As another example, the pressure of the contact surface 144 on the tragus 210 of the user may be within a range of 0 to 2 kPa. As another example, the pressure of the contact surface 144 on the tragus 210 of the user may be within a range of 0 to 0.5 kPa. In some embodiments, to ensure the comfort when the acoustic output device 100 is worn and avoid interference of the tragus 210 on the sound when the tragus 210 is higher than the outlet hole 142, at least a portion of the housing 140 needs to bypass the tragus 210 of the use. The contact surface 144 of the housing 140 near the face of the user may also include a recessed portion 144-2. The recessed portion 144-2 may bypass the tragus 210 of the user such that the outlet hole 142 may bypass the tragus 210 and is located within the target region. In some embodiments, the recessed portion 144-2 may include a recessed structure, and the shape of the recessed structure may be adapted to the shape of the tragus 210. For example, as shown in FIG. 4, along the X-axis direction, a point on the tragus 210 that is farthest from the auricle 220 may be determined as a start point A of the recessed structure; the highest point of the tragus may be determined as an apex E of the recessed structure. The housing 140 of the acoustic output device 100 may contact the tragus 210 at the apex E of the recessed structure and at a start point A of the recessed structure, and there may be a smooth transition curve between the start point A of the recessed structure and the apex E of the recessed structure. The shape of the curve overlaps or is close to the shape of the tragus 210. In some embodiments, a width of the recessed structure may match a width w of the tragus 210, and a depth of the recessed structure matches a height h of the tragus 210. Merely by way of example, the width of the recessed structure may be greater than or equal to the width w of the tragus 210, and the depth of the recessed structure may be greater than or equal to the height h of the tragus 210. In some embodiments, the height h of the tragus 210 may be within a range of 1 mm to 10 mm, and the width w may be within a range of 3 mm to 11 mm. Correspondingly, the width of the recessed structure may be greater than or equal to 4.4 mm and the depth of the recessed structure may be greater than or equal to 7 mm. For example, the width of the recessed structure may be 7 mm and the depth of the recessed structure may be 4.4 mm.

FIG. 5 is a schematic diagram illustrating an acoustic output device according to some embodiments of the present disclosure.

Further in conjunction with FIG. 5, in some embodiments, along a thickness direction (i.e., the Z-axis direction) of the housing 140, a distance between the center point D of the outlet hole 142 and the apex E of the recessed structure is d. In some embodiments, the recessed structure may be attached to the tragus. In such cases, along the thickness direction of the housing 140, the lowest point of a side of the housing 140 proximate to the auricle 220, may be the highest point of the tragus. A height of point D may include a height h of the tragus and the distance d. That is, in the Z-axis direction, an absolute value of coordinates of the point D may be expressed as Z_{D}=h+d. In some embodiments, h may be within a range of 1 mm to 10 mm, and d may be within a range of 0.5 mm to 10 mm. Merely by way of example, h may be 4.4 mm, d may be 1 mm, and Z_{D} may be 5.4 mm.

In some embodiments, to improve the output effect of the acoustic output device 100 so that the user may receive a clear sound signal, the position of the outlet hole 142 may also be configured in conjunction with the process shown in FIG. 3A or FIG. 3B. The coordinates (X_{D}, Y_{D}, Z_{D}) of point D in the Cartesian coordinate system satisfies:

$$\{ \begin{matrix}{X}_{D}^{2} + {Y}_{D}^{2} \leq {r}^{2} \\ {Z}_{D} = h + d\end{matrix} , \qquad ( 1 )$$

where r may be in a range of 20 mm-30 mm, h may be in a range of 1 mm-10 mm, and d may be in a range of 0.5 mm-10 mm. Merely by way of example, a value of r may be 20 mm, a value of h may be 4.4 mm, and a value of d may be 1 mm. At this point, a vertical coordinate Z_{D} of point D may be Z_{D}=5.4 mm, and a horizontal coordinate X_{D} of point D and a vertical coordinate Y_{D} of point D satisfy: X_{D}²+Y_{D}^{2≤400} mm².

In some embodiments, the recessed structure may include a smooth structure to avoid bumps or sharp corners on the recessed structure from scraping against the tragus 210 and causing discomfort to the user, thereby improving the comfort of the user for use. For example, a surface of the recessed structure may include a chamfer structure, an arc structure, or the like. In some embodiments, to improve the wearing comfort of the acoustic output device 100, an arc degree corresponding to the chamfer structure or the arc structure may be within a range of 80° to 120°. In some embodiments, the arc degree corresponding to the chamfer structure or the arc structure may be 90°.

In some embodiments, a material at the recessed structure may include a hard material (e.g., hard plastic, alloy, etc.). In some embodiments, to further improve the wearing comfort of the acoustic output device 100, the material at the recessed structure may include a soft material (e.g., soft plastic, silicone, soft rubber, fabric, etc.).

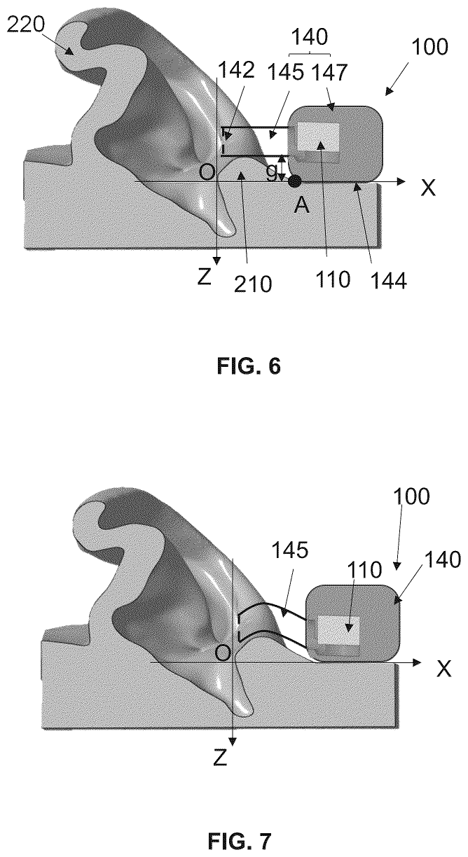

FIG. 6 is a schematic diagram illustrating a positional relationship between an acoustic output device and an ear of a user in a wearing state according to some embodiments of the present disclosure. FIG. 7 is a schematic diagram illustrating a positional relationship between an acoustic output device and an ear of a user in a wearing state according to some embodiments of the present disclosure. In some embodiments, as shown in FIGS. 6 and 7, the housing 140 of the acoustic output device 100 may include a body 147 and a sound guide tube 145 that is in acoustic communication with the loudspeaker 110. The loudspeaker 110 may be disposed inside the body 147. In some embodiments, the body 147 may also include a power supply assembly, a circuit board, or the like. When the user wears the acoustic output device 100, a projection of the body 147 on the XOY plane may be outside a projection of the auricle of the user 220. For example, the projection of the body 147 on the XOY plane may be located on the face in front of the auricle 220. The sound guide tube 145 may be disposed on a side of the body 147 facing the tragus 210. When the user wears the acoustic output device 100, the sound guide tube 145 extends from the body 147 toward the auricle of the user 220, and the outlet hole 142 may be disposed at an end of the sound guide tube 145 close to the auricle of the user 220. In some embodiments, the sound guide tube 145 may be configured to bypass the tragus 210 of the user. In such cases, the contact surface 144 of the housing 140 (or the body 147) close to the face of the user may be a planar surface, which may not include the recessed portion 144-2 shown in FIG. 4. In some embodiments, as shown in FIG. 6, the sound guide tube 145 may be an elongated straight tube, an axis of which may be parallel to the X-axis. To make the sound guide tube 145 bypass the tragus 210 of the user, a distance g between the sound guide tube 145 and the contact surface 144 of the housing 140 along the Z-axis may be greater than or equal to a height h of the tragus 210. Merely by way of example, the height h of the tragus 210 may be 4.4 mm, and correspondingly, a distance g between the sound guide tube 145 and the contact surface 144 of the housing 140 may be greater than or equal to 4.4 mm. Furthermore, a length of the sound guide tube 145 along the X-axis direction may also be set in conjunction with the process shown in FIG. 3A or FIG. 3B so that the outlet hole 142 may be located within the target region. Merely by way of example, the length of the sound guide tube 145 along the X-axis direction may be greater than or equal to a width w of the tragus 210. For example, a length of the sound guide tube 145 along the X-axis direction may be within a range of 1 mm to 30 mm. As another example, the length of the sound guide tube 145 along the X-axis direction may be within a range of 1 mm to 20 mm. In some embodiments, a cross-sectional area of any two or more positions of the sound guide tube 145 may be the same or different. For example, the cross-sectional area of the sound guide tube 145 may be a constant value. As another example, the cross-sectional area of the sound guide tube 145 may gradually increase along an extension direction from the body 147 toward the auricle of the user 220. As another example, the cross-sectional area of the sound guide tube 145 may gradually decrease along the extension direction from the body 147 toward the auricle of the user 220. In some embodiments, the cross-sectional area of the sound guide tube 145 may not be too small to avoid a sound attenuation in the sound guide tube 145 due to boundary sticking. For example, a minimum cross-sectional area of the sound guide tube 145 may be greater than 1 mm². As another example, the minimum cross-sectional area of the sound guide tube 145 may be greater than 2 mm². As yet another example, the minimum cross-sectional area of the sound guide tube 145 may be greater than 4 mm².

In some embodiments, as shown in FIG. 7, the sound guide tube 145 may also be a curved tube, where a curved arc degree of the sound guide tube 145 may match a curved arc degree of the tragus 210 to bypass the tragus 210 of the user, thereby preventing the sound guide tube 145 from causing pressure on the tragus 210, and preventing the tragus 210 from interfering with the sound when the tragus 210 is higher than the outlet hole 142. It should be understood that the sound guide tubes shown in FIGS. 6 and 7 are merely exemplary illustrations and are not limitations of the present disclosure. Based on the principles and methods of the present disclosure, various modifications may be made to the sound guide tube or other components of the acoustic output device 100 to meet the needs of different scenarios. In some embodiments, the position, the shape, the size, or the like of the sound guide tube 145 shown in FIG. 6 or FIG. 7 may be adjusted. For example, the sound guide tube 145 may also be disposed on other sides of the housing 140. As another example, the sound guide tube 145 may have other shapes.

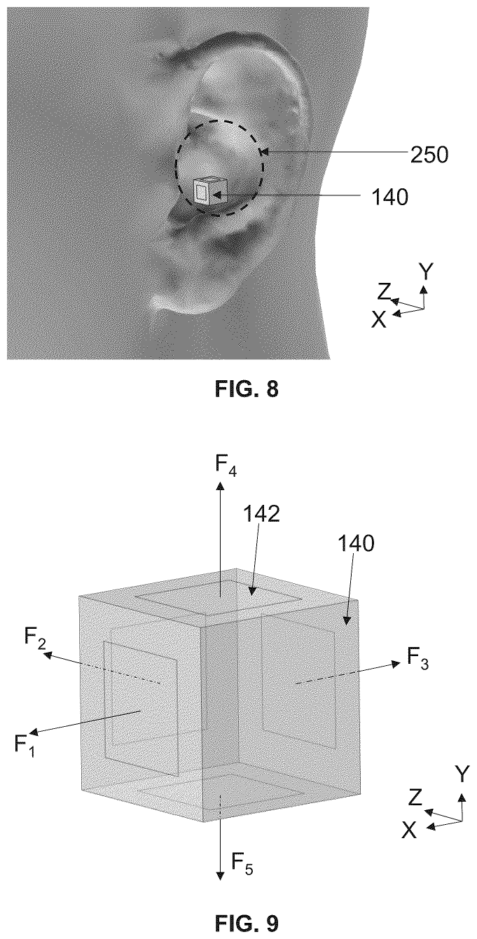

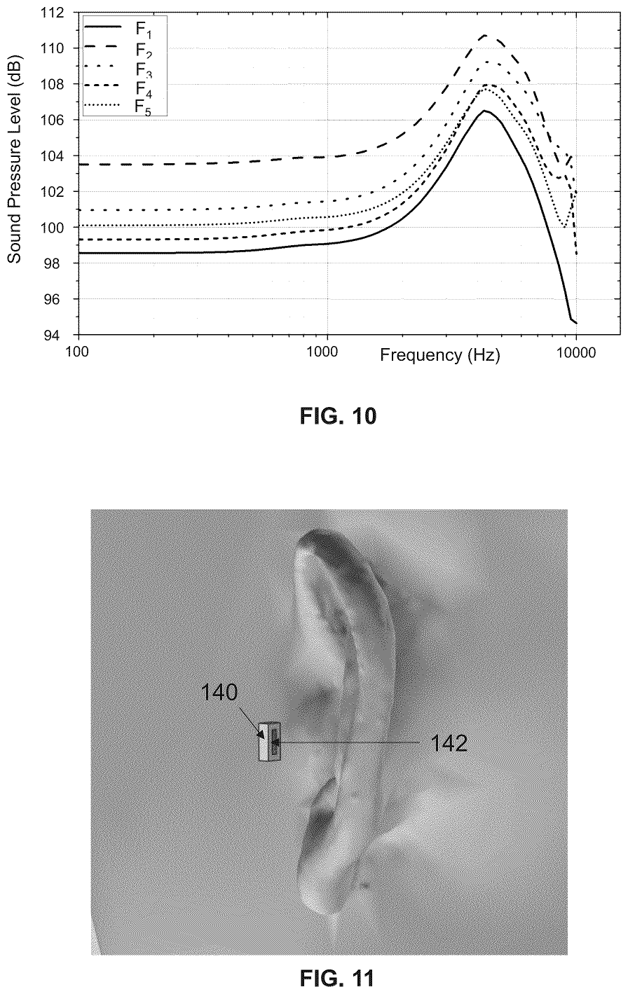

FIG. 8 is a schematic diagram illustrating a position relationship between an outlet hole and an ear of a user according to some embodiments of the present disclosure. FIG. 9 is a schematic diagram illustrating different orientations of outlet holes according to some embodiments of the present disclosure. FIG. 10 is a schematic diagram illustrating frequency response curves of sound emitted by outlet holes of different orientations at an ear of a user according to some embodiments of the present disclosure. In some embodiments, an orientation of the outlet hole 142 relative to the ear of the user may also be configured to improve the sound quality of the acoustic output device 100.

As shown in FIG. 8 and FIG. 9, in some embodiments, the orientation of the outlet hole 142 on the housing 140 relative to the earhole 230 of the user may be set to F₁, F₂, F₃, F₄, F₅, respectively. In conjunction with the three-peripheral Cartesian coordinate system shown in FIG. 3A or FIG. 3B, F₁ indicates that the orientation of the outlet hole 142 is a positive direction of the X-axis (i.e., facing forward), F₂ indicates that the orientation of the outlet hole 142 is a positive position of the Z-axis (i.e., facing inward or facing the earhole 230), F₃ indicates that the orientation of the outlet hole 142 is a negative direction of the X-axis (i.e., facing back), F₄ indicates that the orientation of the outlet hole 142 is a positive direction of the Y-axis (i.e., facing the top), and F₅ indicates that the orientation of the outlet holes 142 is a negative direction of the Y-axis (i.e., facing the bottom).

As shown in FIG. 10, the curves F₁-F₅ represent the frequency response curves of the sound emitted by the outlet holes 142 with the orientations of F₁, F₂, F₃, F₄, and F₅, respectively at the earholes 230. The curve F₂, the curve F₃, the curve F₅, the curve F₄, and the curve F₁ are distributed in order from the top to the bottom. When the horizontal coordinates are the same, a vertical coordinate corresponding to the curve F₂ is the largest, and a vertical coordinate corresponding to the curve F₃, a vertical coordinate corresponding to the curve F₅, a vertical coordinate corresponding to the curve F₄, and a vertical coordinate corresponding to the curve F₁ decrease in sequence. Therefore, when a frequency of an input signal of the loudspeaker 110 is constant, the user hears the greatest sound when the orientation of the outlet hole 142 is F₂ (facing inward). When the orientation of the outlet hole 142 is F₂, F₃, F₅, F₄, and F₁, respectively, the sound heard by the user decreases in sequence. When the frequency of the input signal of the loudspeaker 110 is constant, the louder the sound emitted by the outlet hole 142 of a specific orientation heard by the user, the smaller the driving voltage required for the loudspeaker 110 to emit a sound signal with a constant sound pressure level when the outlet hole 142 adopts the specific orientation, and the smaller the sound leakage of the acoustic output device 100.

Continuing to refer to FIG. 10, in a high-frequency region (e.g., a region near 10000 Hz on the horizontal coordinate in FIG. 10, such as a region within a range of 9000 Hz-10000 Hz on the horizontal coordinate), the high-frequency components that may be heard by the ear of the user corresponding to the different orientations of the outlet holes 142 are listed in descending order as: curve F₃=curve F₄>curve F₂=curve F₅>curve F₁. In such cases, for the different orientations of the outlet holes 142, the more high-frequency components the user hears, the less high-frequency components need to be included in the sound signal emitted by the loudspeaker 110. For example, compared to the sound signal emitted by the loudspeaker 110 when the orientation of the outlet hole 142 is F₁, the sound signal emitted by the loudspeaker 110 when the orientation of the outlet hole 142 is F₃ may contain less high-frequency components to achieve a same high-frequency listening effect. Correspondingly, a high-frequency sound leakage produced by the acoustic output device 100 when the orientation of the outlet hole 142 is F₃ may be smaller.

In some embodiments, to increase a volume of the sound heard by the user and reduce the sound leakage of the acoustic output device 100, the orientation of the outlet holes 142 may be F₂, i.e., the outlet hole 142 may face the earhole of the user. In some embodiments, the orientation of the outlet hole 142 may be configured based on both the direction F₂ and the direction F₃ to increase the high-frequency components of the sound heard by the user, thereby further reducing the sound leakage of the acoustic output device 100. For example, the outlet hole 142 may face a concha cavity 250 located between the direction F₂ and the direction F₃.

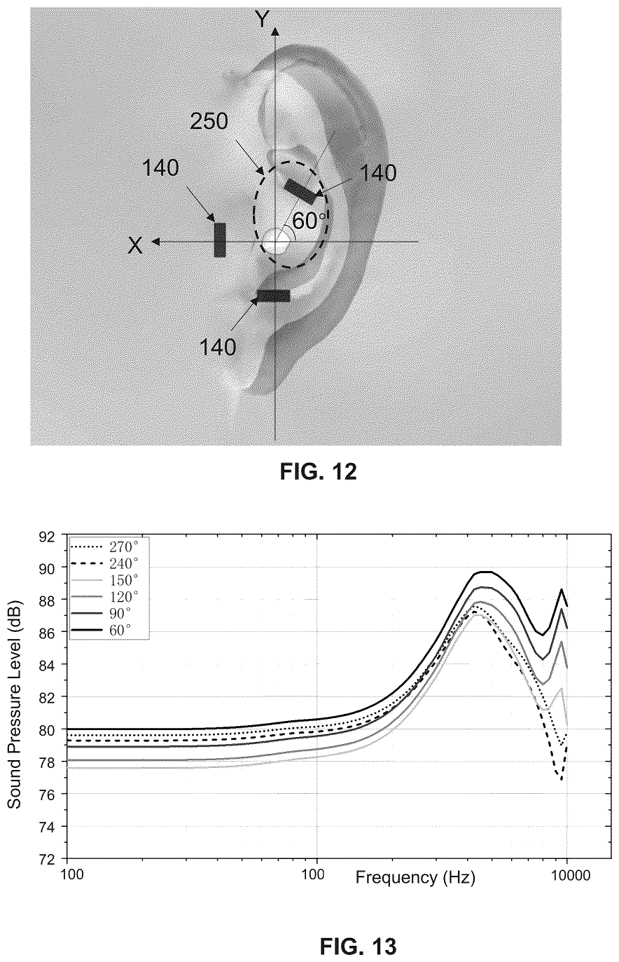

FIG. 11 is a schematic diagram illustrating a position relationship between an outlet hole and an ear of a user according to some embodiments of the present disclosure. FIG. 12 is a schematic diagram illustrating outlet holes located at different positions according to some embodiments of the present disclosure. FIG. 13 is a schematic diagram illustrating frequency response curves of sound emitted by outlet holes located at different positions at an ear of a user according to some embodiments of the present disclosure.

Referring to FIG. 11 and FIG. 12, in some embodiments, when the positions of the outlet holes 142 relative to the earhole of the user are different, the angles at which the sound signal emitted by the acoustic output device 100 enters the earhole of the user 230 may be different. In some embodiments, the angle at which the sound signal emitted by the acoustic output device 100 enters the earhole of the user 230 may be expressed by an angle between a projection of the outlet hole 142 on the XOY plane and a negative direction of the X-axis of the 3D Cartesian coordinate system (or a negative direction of the sagittal axis), where the angle between a projection of the outlet hole 142 on the XOY plane and the negative direction of the X-axis of the spatial Cartesian coordinate system refers to an angle between a line connecting the projection of the outlet hole 142 on the XOY plane and the origin O (or the earhole 230) and the negative direction of the X-axis of the spatial Cartesian coordinate system. In some embodiments, distances between the positions of the outlet holes 142 corresponding to different angles and the earholes 230 may be the same. For example, when the position of the origin O is determined as the position of the earhole 230, the distances between the positions of the outlet holes 142 corresponding to different angles and the origin O may be the same, i.e., the outlet holes 142 at the different positions are all located on a curve corresponding to X_{D}²+Y_{D}²=r². In some embodiments, a value of r may be 10 mm.

In some embodiments, outlet holes 142 with angles (i.e., an angle between the projection of outlet hole 142 on the XOY plane and the negative direction of the X-axis of the Cartesian coordinate system) of 60°, 90°, 120°, 150°, 240°, 270°, respectively, are selected, and the corresponding frequency response curves of the outlet holes 142 are as shown in FIG. 13.

Referring to FIG. 13, in low-and-medium frequency ranges (e.g., in the ranges of 100 Hz-1000 Hz or 100 Hz-2000 Hz, etc.), a curve corresponding to 60°, a curve corresponding to 270°, a curve corresponding to 240°, a curve corresponding to 90°, a curve corresponding to 120°, a curve corresponding to 150°, and a curve corresponding to 150° are distributed sequentially from the top to the bottom. When the horizontal coordinates are the same, vertical coordinates corresponding to the curve corresponding to 60°, the curve corresponding to 270°, the curve corresponding to 240°, the curve corresponding to 90°, the curve corresponding to 120°, the curve corresponding to 150°, and the curve corresponding to 150° decrease sequentially. Therefore, when the angle between the projection of the outlet hole 142 on the XOY plane and the negative direction of the X-axis of the Cartesian coordinate system is within a range of 60° to 90° or 240° to 270°, a sound pressure level of the sound signal received by the ear of the user is relatively large, which indicates that the closer the outlet hole 142 to the auricle of the ear of the user, the larger the sound pressure level received by the ear of the user.

In a high-frequency range (e.g., near 10,000 Hz), for the curve corresponding to 60°, the curve corresponding to 90°, the curve corresponding to 120°, and the curve corresponding to 150°, more high-frequency components may be heard by the ear of the user, and a high-frequency sound leakage corresponding to the high-frequency components of the acoustic output device 100 may be smaller. When the angle between the projection of the outlet hole 142 on the XOY plane and the negative direction of the X-axis is within a range of 60° to 150°, the high-frequency sound leakage of the acoustic output device 100 is relatively small. It is indicated that the high-frequency sound leakage of the acoustic output device 100 is relatively small when the outlet hole 142 is located in an upper portion of the concha cavity 250 of the user. In some embodiments, the upper portion of the concha cavity of the user 250 may refer to a portion of the concha cavity 250 that is located in the positive direction of the Y-axis and bounded by the XOZ plane.

In some embodiments, to increase the volume of the sound heard by the user and reduce the sound leakage of the acoustic output device 100, the outlet hole 142 may be placed close to the auricle of the user. In some embodiments, to increase the high-frequency component of the sound heard by the user, thereby further reducing the sound leakage of the acoustic output device 100, a value of the angle between the projection of the outlet hole 142 on the XOY plane and the negative direction of the X-axis may be within the range of 60° to 90°.

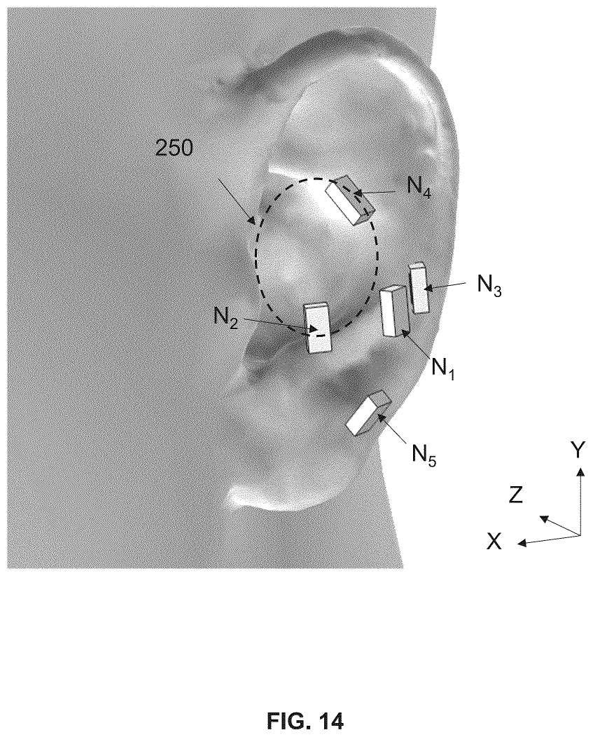

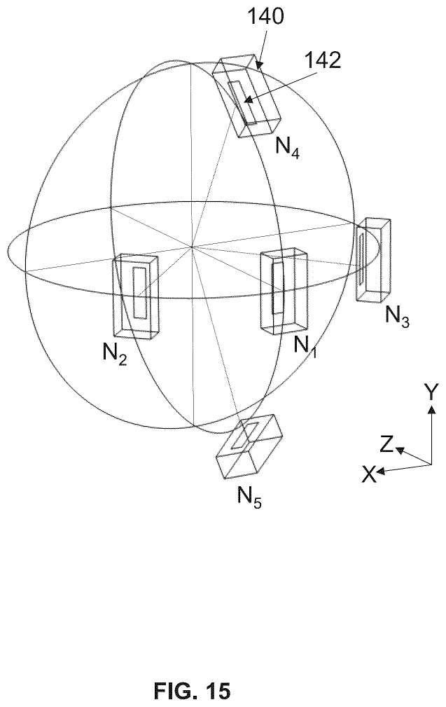

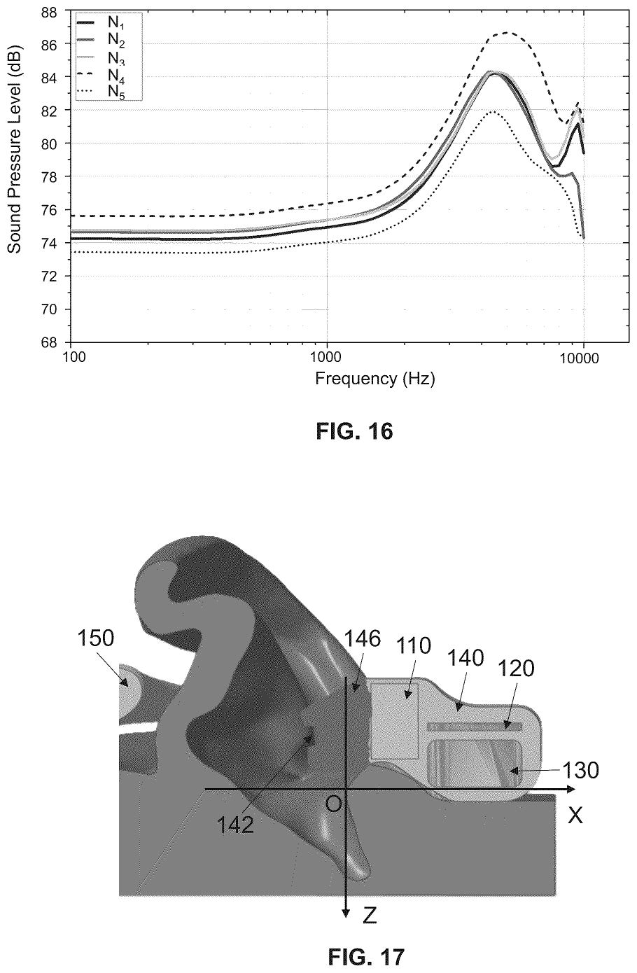

FIG. 14 is a schematic diagram illustrating a position relationship between an outlet hole and an ear of a user according to some embodiments of the present disclosure. FIG. 15 is a schematic diagram illustrating outlet holes located at different positions according to some embodiments of the present disclosure. FIG. 16 is a schematic diagram illustrating frequency response curves of sound emitted by outlet holes located at different positions at the ear of the user according to some embodiments of the present disclosure.

Referring to FIG. 14 and FIG. 15, in some embodiments, the positions of the sound outlet holes 142 relative to the earhole of the user are different such that the angles at which the sound signal emitted by the acoustic output device 100 enters the earhole of the user 230 are different. In some embodiments, to exclude as much as possible the influence of other factors, the distances between the positions of the sound outlet holes 142 and the earhole of the user corresponding to different angles may be controlled to the same. In some embodiments, the outlet holes 142 at different positions may be located on a spherical surface with a center origin O and a radius R. In some embodiments, the radius R of the spherical surface may be within a range of 2 mm to 20 mm. In some embodiments, a value for the radius R may be 15 mm.

In some embodiments, the frequency response curves corresponding to five different positions of the outlet holes 142 located at N₁, N₂, N₃, N₄, and N₅ may be determined respectively. As shown in FIG. 15, N₁ indicates that the outlet hole 142 is located outside the earhole, i.e., the outlet hole 142 is located on a negative axis of the Z-axis, and an angle between the outlet hole 142 and the negative axis of the Z-axis is 0°. N₂ indicates that the outlet hole 142 is located on the left of the earhole, i.e., the outlet hole 142 is located within an XOZ plane, and an angle between the outlet hole 142 and a positive axis of the X-axis is 45°. N₃ indicates that the outlet hole 142 is located on the right of the earhole, i.e., the outlet hole 142 is located within the XOZ plane, and an angle between the outlet hole 142 and the negative axis of the X-axis is 45°. N₄ indicates that the outlet hole 142 is located on the upper side of the earhole, i.e., the outlet hole 142 is located within a YOZ plane, and an angle between the outlet hole 142 and a positive axis of the Y-axis is 45°. N₅ indicates that the outlet hole 142 is located on a lower side of the earhole, i.e., the outlet hole 142 is located within the YOZ plane, and an angle between the outlet hole and a negative axis of the Y-axis is 45°.

Referring to FIG. 16, in a high-frequency region (e.g., near 10,000 Hz), the high-frequency components that may be heard by the ear of the user corresponding to the outlet holes 142 at different positions are, in descending order, as follows: curve corresponding to N₃>curve corresponding to N₁>curve corresponding to N₂, and curve corresponding to N₄>curve corresponding to N₁>curve corresponding to N₅. The more high-frequency components the user hears, the less high-frequency components the sound signal by the loudspeaker 110 through the outlet hole 142 at that position contains, and the smaller the high-frequency sound leakage of the acoustic output device 100. Combined with FIG. 15, comparing the high-frequency components that may be heard by the ears of the user corresponding to different positions of the outlet holes 142 along the X-axis direction: curve corresponding to N₃>curve corresponding to N₁>curve corresponding to N₂, which indicates that the closer the outlet holes 142 are to the auricle of the user, the more high-frequency components the user receives. Comparing the high-frequency components that may be heard by the ears of the user corresponding to the different positions of the outlet holes 142 along the Y-axis direction: curve corresponding to N₄>curve corresponding to N₁>curve corresponding to N₅, which indicates that the closer the outlet hole 142 is to the upper half of the concha cavity 250 of the ear of the user, the more high-frequency components the user receives. Thus, in some embodiments, to increase the high-frequency component of the sound heard by the user and thereby reducing the sound leakage of the acoustic output device 100, the projection of the outlet hole 142 may be close to the projection of the auricle of the user on the XOY plane. In some embodiments, to further increase the high-frequency component of the sound heard by the user and thereby reducing the sound leakage of the acoustic output device 100, the projection of the outlet hole 142 may be located within a projection of the upper portion of the concha cavity 250 on the XOY plane. In the low-and-medium frequency region, the sound pressure level received by the user corresponding to the different positions of the outlet holes 142 are, in descending order, as follows: curve corresponding to N₄>curve corresponding to N₃≈curve corresponding to N₂≈curve corresponding to N₁>curve corresponding to N₅, which indicates that, in conjunction with FIG. 15, the closer the outlet hole 142 is to the upper portion of the concha cavity 250 of the ear of the user, the greater the sound pressure level received by the user. Thus, in some embodiments, to increase the volume of the sound heard by the user, the projection of the outlet hole 142 may be located within the projection of the upper portion of the concha cavity 250 on the XOY plane.

In conjunction with FIG. 14-FIG. 16 and the descriptions thereof, in some embodiments, to increase the volume of the sound heard by the user, and/or to increase the high-frequency components of the sound heard by the user to reduce the sound leakage of the acoustic output device 100, thereby improving the sound quality of the acoustic output device 100, on the XOY plane, the projection of the outlet hole 142 may be within a range of the projection of the upper portion of the concha cavity 250. For example, in three-dimensional space, the outlet hole 142 may be disposed within a region defined by the negative axis of the Z-axis, the positive axis of the Y-axis, and the negative axis of the X-axis.

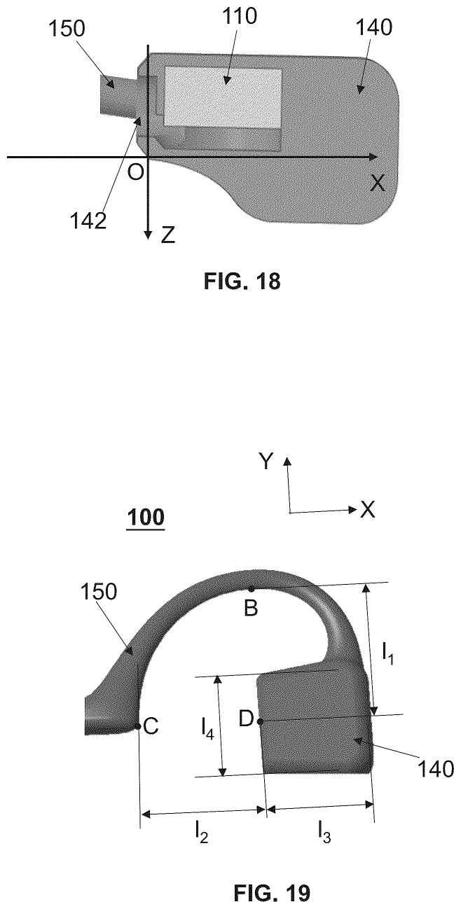

FIG. 17 is a schematic diagram illustrating another exemplary acoustic output device according to some embodiments of the present disclosure. FIG. 18 is a schematic diagram illustrating another exemplary acoustic output device according to some embodiments of the present disclosure. Referring to FIG. 17 with FIG. 18, in some embodiments, the orientation of the loudspeaker 110 may be the same as or perpendicular to the orientation of the outlet hole 142. The orientation of the loudspeaker 110 may refer to a vibration direction of the vibrating component (e.g., a diaphragm or a vibrating plate, etc.) of the loudspeaker 110. For example, as shown in FIG. 17, the vibration direction of the vibration component of the loudspeaker 110 is parallel to the X-axis, and the outlet hole 142 faces a direction of the negative axis of the X-axis such that the orientation of the loudspeaker 110 is consistent with the orientation of the outlet hole 142. For example, the orientation of the loudspeaker 110 may face the outlet hole 142, and the sound signal emitted by the loudspeaker 110 may directly enter the earhole of the user through the outlet hole 142, which reduces interference in ta propagation process of the sound signals such that the user may receive a clear sound. As another example, as shown in FIG. 18, a vibration direction of the vibration component of the loudspeaker 110 is parallel to the Z-axis, and the outlet hole 142 faces a direction of the negative axis of the X-axis such that the orientation of the loudspeaker 110 is perpendicular to the orientation of the outlet hole 142. The sound signal emitted by the loudspeaker 110 passes through an interior space of the housing 140 and then is transmitted out through the sound outlet hole 142.

In some embodiments, as shown in FIG. 17, the housing 140 may include an extending portion 146. The extending portion 146 may be configured to extend an acoustic path between the outlet hole 142 and the loudspeaker 110 so that the outlet hole 142 may be located above the earhole of the user to reduce a distance between the outlet hole 142 and the earhole of the user, thereby reducing a loss of the sound signal emitted from the loudspeaker 110 in the propagation process, and improving the volume and the sound quality of the sound signal received by the user. In some embodiments, the extending portion 146 may be a portion of the housing 140. For example, the extending portion 146 is integrally molded with the housing 140, and the outlet hole 142 is disposed at an end of the extending portion 146. In some embodiments, the extending portion 146 may also be mechanically connected to the housing 140 as an independent component. Merely by way of example, the extension portion 146 and the housing 140 may respectively include one outlet hole, and the extension portion 146 is detachably connected to the housing 140. The extension portion 146 may be connected to the housing 140 to reduce the distance between the sound outlet hole and the earhole of the user, or the extension portion 146 may be removed and the sound signal may be exported directly through the sound outlet hole on the housing 140. In some embodiments, the extending portion 146 may be a sound guide tube connected to the housing 140 (e.g., the sound guide tube 145 as shown in FIG. 6 and FIG. 7). In some embodiments, an interior of the housing 140 may also include a circuit board 120 and a power supply assembly 130, as shown in FIG. 17.

FIG. 19 is a schematic diagram illustrating another acoustic output device according to some embodiments of the present disclosure. Referring to FIG. 3A and FIG. 19, in some embodiments, when the user wears the acoustic output device 100, the acoustic output device 100 may have three interaction points with a head of the user. A lower edge of an arc-shaped top of the fixing mechanism 150 may contact an upper portion of the ear at a contact point B; a front edge of an arc-shaped rear side of the fixing mechanism 150 may contact a back of the ear at a contact point C; and the housing 140 may contact the face of the user at a point A.

In some embodiments, a distance between the earhole 230 (i.e., the origin O) and the point B on the upper portion of the ear is I₁, and correspondingly, a distance between the center point D of the outlet hole 142 and the point B at the lower edge of the arc-shaped top of the fixing mechanism 150 is I₁. A distance between the earhole 230 and point C at the back of the ear is I², and correspondingly, a distance between the center point D of the outlet hole 142 and the point C at the front edge of an arc-shaped rear side of the fixing mechanism 150 is I². The dimension of the fixing structure 150 may be determined based on I₁ and I².

In some embodiments, I₁ may be within a range of 15 mm to 25 mm, and I² may be within a range of 25 mm to 40 mm. In some embodiments, a value of I₁ may be 20 mm, and a value of 12 may be 31.5 mm.

In some embodiments, the fixing mechanism 150 may be a structure with elasticity to allow the fixing mechanism 150 to fit most people. In some embodiments, the fixing mechanism 150 may be produced using a process of wrapping silicone around a memory wire (or other elastomers, such as rubber, etc.).

Referring to FIG. 5 and FIG. 19, in some embodiments, a total length of the housing 140 may be Is (as shown in FIG. 5 and FIG. 17), a total width of the housing 140 may be 14 (as shown in FIG. 19), and a total thickness of the housing 140 may be 15 (as shown in FIG. 5).

In some embodiments, the present disclosure may not overly limit the total length Is or the total width 14 of the housing 140, as long as the outlet hole 142 (point D) is located within the target region, i.e., the point D satisfies the equation: X_{D}²+Y_{D}²≤ r², where r is within a range of 2 mm to 30 mm. In some embodiments, the present disclosure may not overly limit the total thickness 15 of the housing 140, as long as the recessed structure of the housing 140 may bypass the tragus.

The beneficial effects that may be brought by the embodiments of the present disclosure include, but are not limited to: (1) the outlet hole is configured to be placed near the earhole of the user, which improves the sound quality and the volume of the sound signal received by the user; (2) the housing is provided with a recessed portion or a sound guide tube configured to bypass the tragus, which will not cause pressure on the tragus, and the comfort of the acoustic output device for use is improved; (3) the smooth configuration of the recessed portion is set with no sharp corners so that the housing will not scratch the tragus; (4) the fixing mechanism matches the contour of the ear such that the fixing mechanism can clamp the ear and cause small compression on the ear. It should be noted that the beneficial effects that may be produced by different embodiments are different, and in different embodiments, the beneficial effects that may be produced may be a combination of any one or more of the above, or any other beneficial effects that may be obtained.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristics described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, unless specifically described in the claims, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate±20% variation of the value it describes, unless otherwise stated. Accordingly, in some embodiments, the numerical parameters set forth in the written description and attached claims are approximations that may vary depending upon the required properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Therefore, by way of example, but not of limitation, alternative configurations of the embodiments of the application may be utilized in accordance with the teachings herein. Accordingly, embodiments of the present application are not limited to that precisely as shown and described.

1. An acoustic output device, comprising:
a loudspeaker configured to convert an audio signal into a sound signal;
a housing configured to carry the loudspeaker and include an outlet hole in acoustic communication with the loudspeaker; and
a fixing mechanism configured to support the housing such that the outlet hole is placed near an ear of a user and the housing does not block an earhole of the user, wherein on a sagittal plane, a projection of the outlet hole is within a target region with a projection of the earhole of the user as a center and a radius of 20 mm.

2. The acoustic output device of claim 1, wherein the housing includes a contact surface configured to contact a face of the user when the user wears the acoustic output device.

3. The acoustic output device of claim 2, wherein a ratio of an area of a portion of the contact surface that is in contact with the face of the user to a total area of the contact surface is within a range of 0.05 to 1.

4. The acoustic output device of claim 2, wherein the contact surface includes a recessed portion, and the recessed portion is configured such that at least a portion of the housing bypasses a tragus of the user such that the projection of the outlet hole is within the target region.

5. The acoustic output device of claim 4, wherein the recessed portion includes a chamfer structure or an arc structure.

6. The acoustic output device of claim 5, wherein an arc degree corresponding to the chamfer structure or the arc structure is within a range of 80° to 120°.

7. The acoustic output device of claim 4, wherein a width of the recessed portion along a sagittal axis direction is greater than 7 mm.

8. The acoustic output device of claim 4, wherein a depth of the recessed portion along a coronal axis direction is greater than 4.4 mm.

9. The acoustic output device of claim 2, wherein when the user wears the acoustic output device, a pressure of the contact surface on a tragus of the user is within a range of 0 to 2 kPa.

10. The acoustic output device of claim 1, wherein the housing includes a body and a sound guide tube, a projection of the body on the sagittal plane is outside a projection of an auricle of the user on the sagittal plane, the loudspeaker is disposed within the body, and the outlet hole is in acoustic communication with the loudspeaker through the sound guide tube.

11. The acoustic output device of claim 10, wherein the sound guide tube is configured to bypass a tragus of the user such that the outlet hole is within the target region.

12. The acoustic output device of claim 10, wherein a length of the sound guide tube is within a range of 1 mm to 30 mm.

13. The acoustic output device of claim 10, wherein a minimum cross-sectional area of the sound guide tube is greater than 2 mm².

14. The acoustic output device of claim 1, wherein a vibration direction of the loudspeaker is parallel to an orientation of the outlet hole.

15. The acoustic output device of claim 1, wherein a vibration direction of the loudspeaker is perpendicular to an orientation of the outlet hole.

16. The acoustic output device of claim 1, further comprising:
a power supply assembly configured to provide electrical power to the acoustic output device; and
a circuit board configured to connect two or more components of the acoustic output device, wherein projections of the power supply assembly and the circuit board on the sagittal plane are outside a projection of an auricle of the user on the sagittal plane.

17. The acoustic output device of claim 1, wherein the outlet hole faces the earhole of the user.

18. The acoustic output device of claim 1, wherein the outlet hole faces a concha cavity of the user.

19. The acoustic output device of claim 1, wherein, on the sagittal plane, an angle between a line connecting the projection of the outlet hole and the projection of the earhole and a negative direction of a sagittal axis is within a range of 60° to 90°.

20. An acoustic output device, comprising:
a loudspeaker configured to convert an audio signal into a sound signal;
a housing configured to carry the loudspeaker and include an outlet hole in acoustic communication with the loudspeaker; and
a fixing mechanism configured to support the housing such that the outlet hole is placed near an ear of a user and the housing does not block an earhole of the user, wherein
at least a portion of the housing bypasses a tragus of the user and includes the outlet hole.

21-39. (canceled)
